(19) United States
(12) Patent Application Publication
(10) Pub. No.: US 2008/0096705 A1
(43) Pub. Date: Apr. 24, 2008

(54) Structure of mechanical arm transmission structure

(76) Inventor: Shu Man Chang, Taipei City (TW)

Correspondence Address: BIRCH STEWART KOLASCH & BIRCH, PO BOX 747, FALLS CHURCH, VA, 22040-0747, US

(21) Appl. No.: 11/582,999

(22) Filed: Oct. 19, 2006

(51) Int. Cl. F16H 61/00

(52) U.S. Cl. 474/70

(57) ABSTRACT

A mechanical arm transmission structure includes a tubular horizontal base, a drive belt wheel and a driven belt wheel mounted inside the horizontal base, a transmission belt mounted on the drive belt wheel and the driven belt wheel with the upper part thereof suspending above the horizontal base, a motor mounted outside the horizontal base for rotating the drive belt wheel through a speed reducer, a slide movable with the transmission belt along longitudinal rails at the top of the horizontal base and carrying a mechanical arm, and a holding down block fastened to the bottom side of the slide to affix the slide to the upper part of the transmission belt for allowing movement of the slide with the transmission belt along the longitudinal rails.

### BACKGROUND OF THE INVENTION

1. Field of the Invention

The present invention relates generally to mechanical arms and more specifically, to a mechanical arm transmission structure, which has the lower part of the transmission belt to be received in the hollow horizontal base and uses a toothed engagement structure to secure the slide carrying the mechanical arm to the transmission belt for positive transmission.

2. Description of the Related Art

Nowadays, mechanical arms are intensively used for different industrial applications. The invention pertains to an improvement on the arrangement of a mechanical arm transmission structure.

FIGS. 5˜7 show a mechanical arm transmission structure according to the prior art. According to this design, the mechanical arm transmission structure comprises a rectilinear base 60, which has two longitudinal rails 61 arranged in parallel on the top, and a slide 70 coupled to and movable along the longitudinal rails 61. The slide 70 has a cross section shaped like a channel bar (see FIG. 6), and two sliding grooves 71 respectively coupled to the longitudinal rails 61. The mechanical arm transmission structure further comprises a motor 83 mounted on one end of the rectilinear base 60, a speed reducer 84 coupled to the output shaft of the motor 83, a drive belt wheel 81 pivoted to the rectilinear base 60 near the motor 83 and coupled to the speed reducer 84, a driven belt wheel 82 pivoted to the other end of the rectilinear base 60, and a transmission belt 80 mounted on the drive belt wheel 81 and the driven belt wheel 82 and suspending above the rectilinear base 60. The transmission belt 80 has an upper part 80a and a lower part 80b respectively protruding over the slide 70. The slide 70 extends over the transmission belt 80. Further, a holding down block 90 is fastened to the slide 70 to secure the slide 70 to the transmission belt 80, for enabling the slide 70 to be moved with the transmission belt 80 along the longitudinal rails 61.

The aforesaid mechanical arm transmission structure is still not satisfactory in function due to the following drawbacks:

1. The transmission belt 80 is suspending above the rectilinear base 60 and exposed to the outside, external bodies may fall to the top wall of the lower part 80b of the transmission belt 80 and carried by the lower part 80b of the transmission belt 80 to the driven belt wheel 82 to rub against the driven belt wheel 82, causing disconnection of the transmission belt 80 from the driven belt wheel 82. Further, the operator's cloth may be jammed in the transmission mechanism accidentally, resulting in potential injury.

2. Because the transmission belt 80 is suspending above the rectilinear base 60 and the slide 70 extends over the top side of the transmission belt 80, the mechanical arm transmission structure has a great mechanical height, resulting in a large size of the mechanical arm transmission structure.

### SUMMARY OF THE INVENTION

The present invention has been accomplished under the circumstances in view. It is the main object of the present invention to provide a mechanical arm transmission structure, which enhances the working safety, prevents falling of external bodies to the inside of the transmission mechanism, and effectively reduces the mechanical height.

To achieve this and other objects and according to one aspect of the present invention, the mechanical arm transmissions structure comprises a tubular horizontal base, a drive belt wheel and a driven belt wheel mounted inside the horizontal base, a transmission belt mounted on the drive belt wheel and the driven belt wheel with the upper part thereof suspending above the horizontal base, a motor mounted outside the horizontal base for rotating the drive belt wheel through a speed reducer, a slide movable with the transmission belt along longitudinal rails at the top of the horizontal base and carrying a mechanical arm, and a holding down block fastened to the bottom side of the slide to affix the slide to the upper part of the transmission belt for allowing movement of the slide with the transmission belt along the longitudinal rails.

According to another aspect of the present invention, the upper part of the transmission belt has a toothed bottom wall, and the holding down block has a toothed top wall meshed with the toothed bottom wall of the upper part of the transmission belt.

### BRIEF DESCRIPTION OF THE DRAWINGS

FIG. 1 is an elevational view of a mechanical arm transmission structure according to the present invention.

FIG. 2 is a longitudinal front view of the mechanical arm transmission structure according to the present invention.

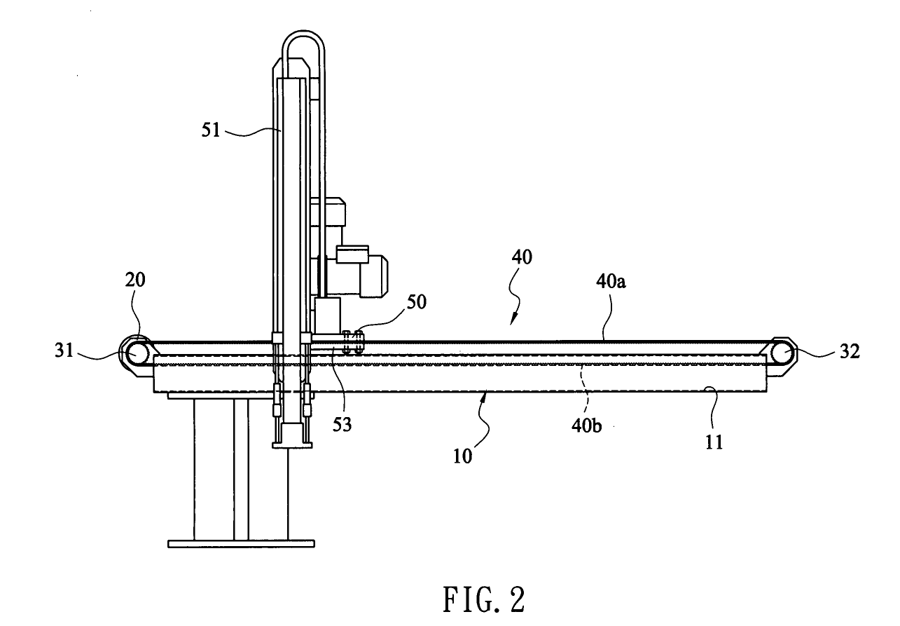

FIG. 3 is transverse end view of the mechanical arm transmission structure according to the present invention.

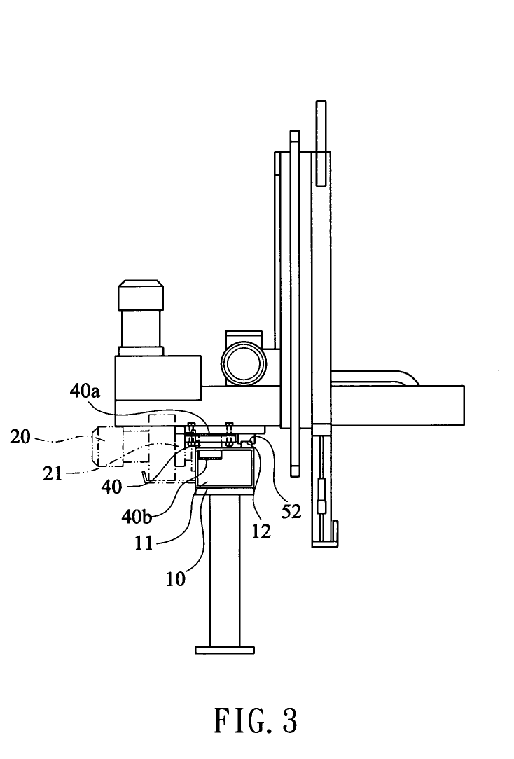

FIG. 4 is an enlarged view of a part of the present invention, showing the connection between the slide and the transmission belt

FIG. 5 is a front view of a mechanical arm transmission structure according to the prior art.

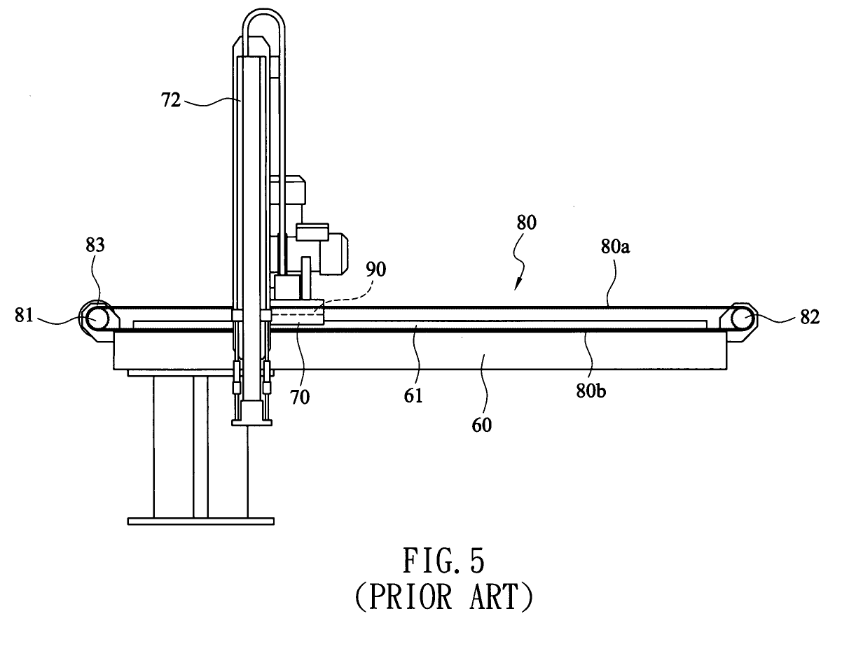

FIG. 6 is a top view of the mechanical arm transmission structure according to the prior art.

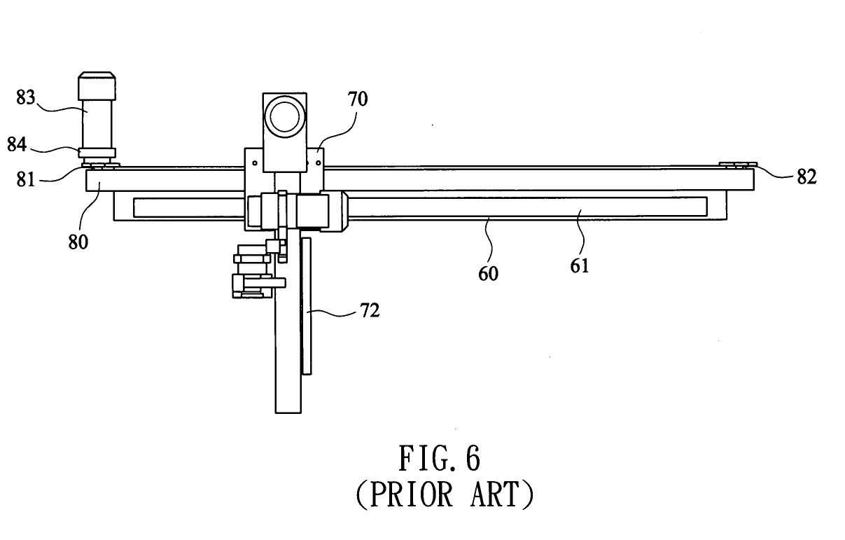

FIG. 7 is an end view of the mechanical arm transmission structure according to the prior art.

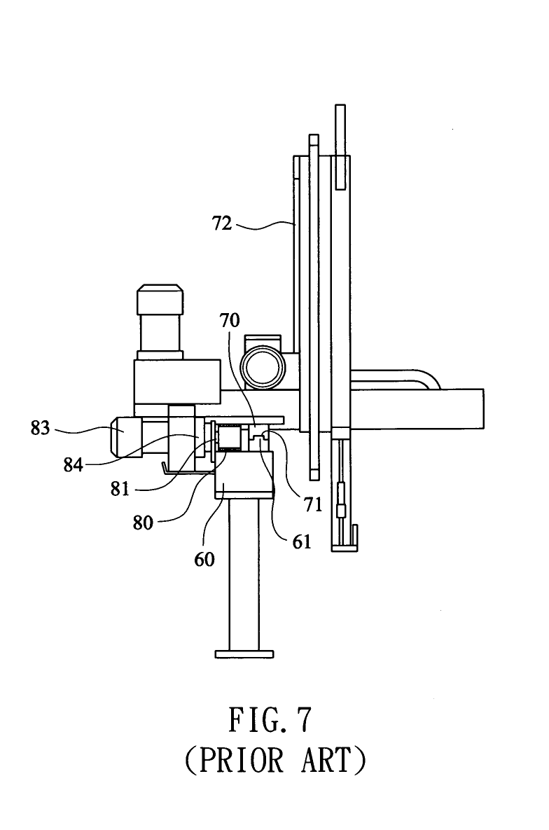

### DETAILED DESCRIPTION OF THE INVENTION

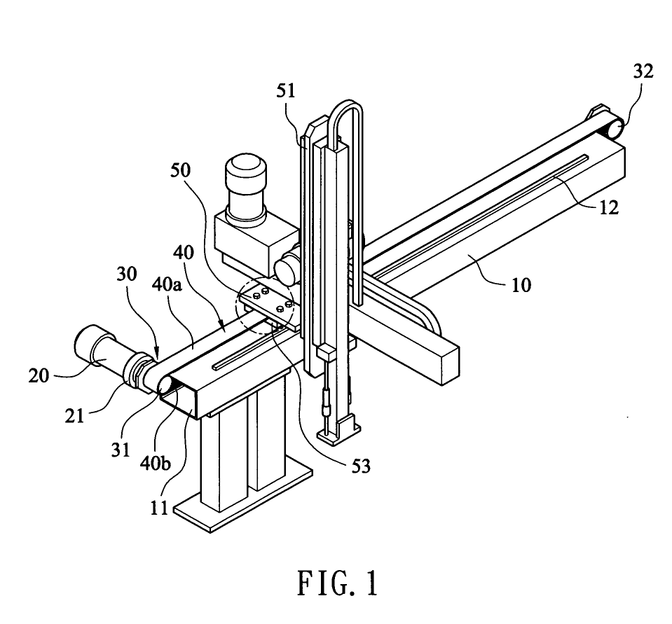

Referring to FIGS. 1˜3, a mechanical arm transmission structure in accordance with the present invention is shown comprised of a horizontal base 10, a motor 20, a transmission mechanism 30, and a slide 50.

The horizontal base 10 is a rectangular tube having a longitudinal receiving space 11 extending to through two distal ends thereof and a pair of longitudinal sliding rails 12 arranged in parallel on the top side thereof.

The motor 20 is fixedly fastened to one end of the horizontal base 10 corresponding to the open side of the longitudinal receiving space 11, adapted to rotate the transmission mechanism 30 through a speed reducer 21 (i.e., the motor 20 has a speed reducer coupled to the output shaft thereof).

The transmission mechanism 30 comprises a drive belt wheel 31 coupled to the speed reducer 21 for rotation by the motor 20, a driven belt wheel 32, and a transmission belt 40. The drive belt wheel 31 and the driven belt wheel 32 are respectively pivotally mounted inside the longitudinal receiving space 11 of the horizontal base 10 near the two distal ends of the horizontal base 10. The transmission belt 40 is an endless belt mounted on the drive belt wheel 31 and the driven belt wheel 32, having an upper part 40a suspending above the horizontal base 10 below the slide 50 and a lower part 40b extending through the longitudinal receiving space 11.

The slide 50 carries a mechanical arm 51 at the top side, having two sliding grooves 52 formed on the bottom side and respectively coupled to the longitudinal sliding rails 12 for allowing reciprocating movement of the slide 50 along the longitudinal sliding rails 12.

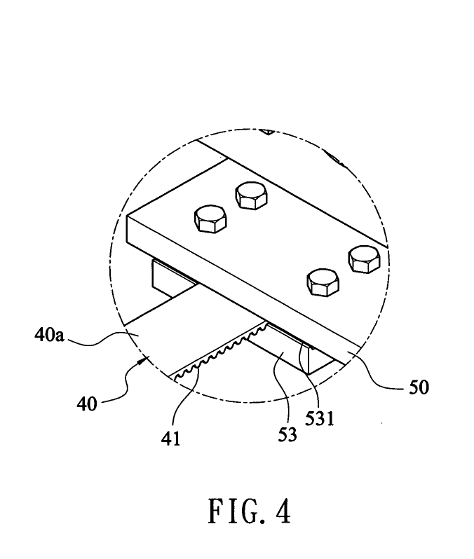

Referring to FIG. 4 and FIG. 1 again, a holding down block 53 is fastened to the bottom side of the slide 50, having a toothed top wall 531. The upper part 40a of the transmission belt 40 is inserted through the gap between the slide 50 and the holding down block 53, having a toothed bottom wall 41 meshed with the toothed top wall 531 of the holding down block 53. Therefore, the slide 50 is positively secured to the transmission belt 40 and movable with the transmission belt 40 along the longitudinal rails 12.

As indicated above, the horizontal base is made in the form of a rectangular tube, allowing the drive belt wheel and driven belt wheel and the lower part of the transmission belt to be received in the longitudinal receiving space of the horizontal base to enhance the working safety, to prevent falling of external bodies to the inside of the transmission mechanism, and to effectively reduce the mechanical height.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A mechanical arm transmission structure comprising:
a horizontal base, said horizontal base having a longitudinal receiving space extending to one end thereof and a pair of longitudinal sliding rails arranged in parallel on a top side thereof;
a motor fixedly fastened to said horizontal base, said motor having a speed reducer coupled to an output shaft thereof;
a transmission mechanism mounted in said horizontal base, said transmission mechanism comprising a drive belt wheel and a driven belt wheel mounted in said longitudinal receiving space near two opposite ends of said horizontal base, said drive belt wheel being coupled to said speed reducer and rotatable by said speed reducer, and a transmission belt mounted on said drive belt wheel and said driven belt wheel, said transmission belt being an endless belt mounted on said drive belt wheel and said driven belt wheel and having an upper part suspending above said horizontal base and a lower part extending through said longitudinal receiving space, said upper part having a toothed bottom wall;
a slide movable with said transmission belt along said longitudinal rails, said slide carrying a mechanical arm at a top side thereof and having two sliding grooves formed on a bottom side thereof and respectively coupled to said longitudinal sliding rails for allowing reciprocating movement of said slide along said longitudinal sliding rails; and.
a holding down block fastened to the bottom side of said slide to affix said slide to said upper part of said transmission belt, said holding down block having a toothed top wall meshed with the toothed bottom wall of said upper part of said transmission belt.

2. A mechanical arm transmission structure comprising:
a horizontal base, said horizontal base having a longitudinal receiving space extending to one end thereof and a pair of longitudinal sliding rails arranged in parallel on a top side thereof;
a motor fixedly fastened to said horizontal base, said motor having a speed reducer coupled to an output shaft thereof;
a transmission mechanism mounted in said horizontal base, said transmission mechanism comprising a drive belt wheel and a driven belt wheel mounted in said longitudinal receiving space near two opposite ends of said horizontal base, said drive belt wheel being coupled to said speed reducer and rotatable by said speed reducer, and a transmission belt mounted on said drive belt wheel and said driven belt wheel, said transmission belt being an endless belt mounted on said drive belt wheel and said driven belt wheel and having an upper part suspending above said horizontal base and a lower part extending through said longitudinal receiving space;
a slide movable with said transmission belt along said longitudinal rails, said slide carrying a mechanical arm at a top side thereof and having two sliding grooves formed on a bottom side thereof and respectively coupled to said longitudinal sliding rails for allowing reciprocating movement of said slide along said longitudinal sliding rails; and.
a holding down block fastened to the bottom side of said slide to affix said slide to said upper part of said transmission belt for allowing said transmission belt to move said slide along said longitudinal rails during operation of said motor.

3. The mechanical arm transmission structure as claimed in claim 2, wherein said upper part of said transmission belt has a toothed bottom wall; said holding down block has a toothed top wall meshed with the toothed bottom wall of said upper part of said transmission belt.
